(19) United States
(12) Patent Application Publication
(10) Pub. No.: US 2011/0002413 A1
(43) Pub. Date: Jan. 6, 2011

(54) TRANSMITTER COVERAGE IDENTIFICATION USING A CONTINUOUS WAVE TONE

(75) Inventors: Krishna Kiran Mukkavilli, San Diego, CA (US); Raghuraman Krishnamoorthi, San Diego, CA (US); Fuyun Ling, San Diego, CA (US); Ben A. Saidi, San Diego, CA (US); William A. Drennen, San Diego, CA (US)

Correspondence Address: McDermott Will & Emery LLP, 600 13th Street, NW, Washington, DC, 20005-3096, US

(73) Assignee: QUALCOMM INCORPORATED, San Diego, CA (US)

(21) Appl. No.: 12/496,473

(22) Filed: Jul. 1, 2009

(51) Int. Cl. H04L 27/00

(52) U.S. Cl. 375/295

(57) ABSTRACT

A methodology for transmitter identification for a single frequency network is provided using a single CW tone. The tone can be transmitted outside the transmitter's active band. It is possible to arrive at significant overlap between the tone coverage area and the coverage area of a neighboring transmitter without disturbing the operations by picking the tone location and power appropriately.

This application claims priority to U.S. patent application Ser. No. 12/165,661, filed Jul. 1, 2008 entitled Transmitter Coverage Identification Using a Continuous Wave Tone, which has been assigned to Qualcomm Incorporated.

### BACKGROUND

Multicast systems which use orthogonal frequency-division multiplexing (OFDM) offer significant advantages over sending content via other methods. These advantages include significantly greater capacity in providing content to users. This content includes real time and non-real time multimedia services. By comparison, unicast systems offering services through, for instance, a cellular/PCS network must employ transmission techniques directed at specific users that can significant tax the available capacity of the communications network.

OFDM splits the available communications spectrum into N orthogonal sub-carriers with a spacing of 1/(N). N typically ranges from 644 to 8,192. Data is provided on N equally spaced apart orthogonal subcarriers (tones), across the available bandwidth, which function as data streams and provide a communications channel for transmission through a single frequency network (SFN). Instead of using a single carrier with a data rate of M modulation symbols/sec, OFDM uses N subcarriers with a data rate of M/N modulation symbols/sec. Symbols are collections of information bits.

In an OFDM broadcast system such as Forward Link Only (FLO) as used with QUALCOMM Incorporated's MediaFLO™ mobile multimedia multicast system, transmission is contemplated as occurring over VHF/UHF/L-band frequencies of 5, 6, 7 and 8 MHz channel bandwidths. Typically 4,096 (4K) subcarriers are employed in a FLO system modulated according to well known QPSK or QAM modulation (e.g. 16-QAM alphabet) schemes. In the United States, a 6 MHz channel bandwidth is allocated for the applicable spectrum and very stringent requirements are placed by the Federal Communications Commission (FCC) on sidebands outside of the allocated bandwidth. The subcarriers usually span a bandwidth which is smaller than the allocation. For instance, 4K subcarriers may span a 5.55 MHz bandwidth. Inverse Fast Fourier Transforms (IFFTs) are implemented at the transmitter of an OFDM system while Fast Fourier Transforms (FFTs) are implemented at an OFDM receiver.

Because transmitted communication signals follow several propagation paths, e.g. paths due to reflections off of buildings, the ground and other structures, multiple copies of a signal will arrive at a receiver with different intensities, phase offsets and delay. These signal copies may constructively or destructively interfere with one another. When the delay spread of multipath signals arriving at different times exceeds a significant fraction of the time span of the symbol, difficulty is encountered in recovering transmitted information. This condition is characterized as inter-symbol interference (ISI). ISI can lead to an increased bit error rate and can reduce the achievable channel data rate.

Guard intervals are provided in FLO systems to further reduce ISI. If the guard interval is chosen such that it is longer in duration that the maximum channel delay spread, multipath components from one symbol will not be able to interfere with adjacent symbols. However, inter-carrier interference (i.e., cross-talk or interference between two different sub-carriers) must also be accounted for. This occurs when orthogonality among signals is lost and the multipath delay becomes larger than the guard interval time Typically, elimination of inter-carrier interference is accomplished by use of a cyclic prefix whereby a copy of the last portion of a data symbol is appended to the front of the symbol during a guard interval. The cyclic prefix results from well-known considerations involving convolving a cyclically-extended OFDM symbol with its channel. The cyclic prefix is a replica of some fractional part of the OFDM symbol. For instance, the cyclic prefix may represent ⅛^{th} of the useful interval of a OFDM symbol. The length of the prefix is chosen such that the delayed versions of the previous symbol only distort the cyclic prefix and not the actual data part of the OFDM symbol. Multipath delay spreads must be less than the cyclic prefix in order to properly recover information according to a methodology of removing inter-carrier interference. Inter-symbol interference caused by the addition of the cyclic prefix is removed by discarding the cyclic prefix, which is redundant information, at the receiver.

In addition to the cyclic prefix and guard bands, symbols known as pilot tones are often inserted into the OFDM symbol. This helps with channel estimation. The pilot signals and data are part of a super frame structure that is typically used with a FLO system. For instance, a FLO super frame is of a one second duration for use with 5 through 8 MHz bandwidths. In addition to pilot signals, the super frame includes overhead information symbols (OIS) for describing the location of data for media services, and data for wide are and local area service.

One advantage of a multicast system such as FLO is its use of a limited number of transmitters. However, in some instances, system performance can be improved by implementing additional transmitters. Determinations as to where to place transmitting towers should include the consideration that channel delay spread be less that the cyclic prefix. The cyclic prefix is typically 512 chips. While FLO can still work with some performance degradation in conditions where the delay spread exceeds the cyclic prefix duration of 512 chips, the performance degradation depends on the amount of energy outside the cyclic prefix compared to the energy contained within the cyclic prefix. Given the sensitivity of FLO performance to excess channel energy (channel energy outside cyclic prefix), it is important to ensure that the delay spread in a FLO network is minimized to meet the design assumptions. Additionally, care must be taken in operating more than one transmitter to avoid the interference problems caused by delay spreads discussed above.

There are several techniques that can be adopted to manage the delay spread in a FLO network. For instance, by advancing or delaying the start of transmission of a superframe at one transmitter with respect to another, the delay spread at a given point in the network can be increased or decreased beyond what is experienced due to normal propagation delays. Similarly, the delay spread can be managed by decreasing the transmit power from one of the transmitters or even changing the direction of the transmission beam.

The implementation of any of the delay spread management techniques mentioned above would sometimes require the measurement of received signal power from each of the transmitters at a given point in the network. The single frequency network (SFN) nature of some networks, such as FLO networks, also presents a problem in distinguishing between the signals received from different transmitters in the network. In particular, the local area is the smallest granularity at which transmitters can be distinguished using the FLO waveform. Therefore, it is important to look at other methods that can be used for measuring signal power from an individual transmitter in the network in the presence of signals from other transmitters. Such a methodology assumes greater importance given its utility when new transmitters need to be added to existing networks without affecting the coverage of an existing network.

### BRIEF DESCRIPTION OF THE DRAWINGS

FIG. 1 is a diagram depicting a scenario involving bringing one transmitter on line within the region of operation of another transmitter.

FIG. 2 illustrates a receive filter connected to a receiver.

### DETAILED DESCRIPTION

A single tone methodology for use with locating new transmitters suitable for, for instance a FLO network and or operating a plurality of existing transmitters is described herein. The single tone methodology allows distinction of transmissions of one transmitter from another.

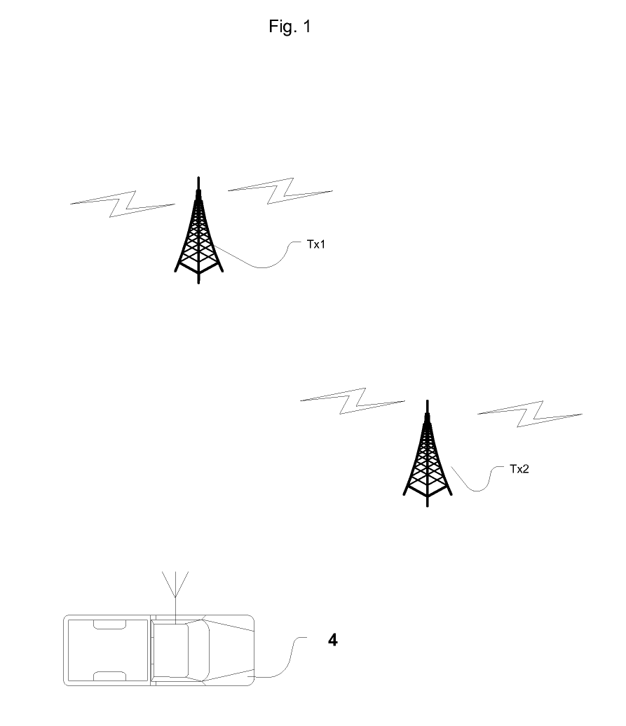

With reference to FIG. 1 which illustrates two transmitters Tx1 and Tx2 respectively, the location and the transmission power of the transmitters (e.g., FLO transmitters) define a certain geographical region of operation. The geographic region of operation around the transmitter Tx1 defines, for instance, where a signal such as a signal from that transmitter can be decoded successfully by a receiver (e.g., FLO receiver). FIG. 1 may depict a scenario involving bringing one transmitter on line within the region of operation of another transmitter. For instance, a FLO transmitter which may be representative of transmitter Tx2 is to be used in conjunction with an existing active FLO transmitter (Tx1) to extend the existing coverage region. The process of bringing up the new transmitter (Tx2) involves determining various parameters such as the delay (or advance) in the start of the super frame boundary for the new transmitter that would minimize interference in the coverage region of Tx1. To perform such an optimization, it is important to determine the coverage region of the new transmitter and the overlap of the coverage region of the two transmitters in particular.

One important consideration in the entire process of implementing a new transmitter is that the users in the coverage region of the existing transmitter Tx1 should see minimal impact (preferably no impact) while the second (new) transmitter Tx2 is brought up. If the default parameters used in bringing up the new transmitter are not optimal, it would lead to interference for the existing users. Predictions based on network models may also not be accurate enough to provide an initial set of parameters for deploying the new transmitters. Further, if the new transmitter is brought up with a FLO signal, then the individual coverage regions cannot be determined in the event of interference, due to the single frequency nature of the transmissions.

A method is provided herein where a single continuous wave (CW) tone from the new transmitter (Tx2) is used to determine the propagation losses and the coverage region. As shown with respect to FIG. 1, transmitter Tx1 will continue to transmit a waveform (e.g., a FLO waveform) while transmitter Tx2 will be brought up with a single continuous wave tone whose location and power is discussed below. The advantage of using a single tone is that the tone can be isolated in the presence of a signal (e.g. FLO signal) and hence the signal power from Tx2 can be measured even in the presence of the signal from Tx1. A reasonably sensitive spectrum analyzer tuned to the tone frequency may be used in the field to detect and measure the signal strength of the tone at various points in the network. The tone will allow distinction of transmission from Tx1 from those of Tx2.

Using this methodology, bringing up a transmitter site would comprise of the following steps.

1. Transmit a CW tone from Tx2 and measure the tone power received at various locations in the field using, for instance, a spectrum analyzer. Vehicle 4 in FIG. 1 equipped with the appropriate monitoring equipment may be used to collect the applicable data.

2. The collected field data would then be used to tune the network prediction tools for that particular geographical area.

3. Finally, the tuned network prediction tools will be used to determine the appropriate transmitter parameters for the new site (Tx2) to be added to the existing network.

The CW tone based method is optimized with considerations allowing tone location as well as tone power to be chosen appropriately. There are two important considerations that need to be taken into account in determining the tone location and the tone power.

Interference from the tone to the transmitted signal (e.g., FLO signal) for users in the existing coverage region should be taken into account. Strong tone interference can lead to system acquisition as well as data demodulation errors in a receiver (e.g., FLO receiver. Tone interference will limit the maximum tone power that can be used.

Accurate tone power measurement using an appropriate device (such as a spectrum analyzer) would require that the tone power be significantly stronger than the background noise and interference (including thermal noise as well as transmitter induced interference). This condition determines the minimum power that can be used for transmission.

The following will be presented with emphases on a FLO network. However, other networks, in particular other SFN networks are contemplated.

The location of the CW tone with respect to the communication spectrum affects both the interference from tone into transmission signal (e.g., FLO signal) as well as the interference from the transmission signal (e.g., FLO) into tone power measurement. For example, for a FLO waveform operating in a 6 MHz spectrum centered around a carrier frequency in the lower 700 MHz band (719 MHz for example) with an FFT bandwidth of 5.55 MHz., the equivalent numbers at baseband are 3 MHz for the total FLO bandwidth and 2.775 MHz for the FFT bandwidth. However, the active bandwidth for FLO where information is transmitted is only 5.41992 MHz (or 2.7099 MHz at baseband). A FLO receiver does not use the spectrum outside the active band and the receiver processing nulls out sub-carriers in this band beyond the initial 4K FFT computation. Further, the FLO spectrum rolls off sharply between 2.7088 MHz and 3 MHz.

There are two possibilities for the location of the tone:

1) In band to FLO signal (tone frequency less than 2.7099 MHz)

2) Out of band to FLO (tone frequency between 2.7099 MHz and 3 MHz)

If the tone is placed inside the FLO active band of operation, then the interference from the tone into the FLO signal and vice versa are maximum. On the other hand, if the tone is placed outside the FLO band of operation, then the tone detection can benefit from spectrum roll off of the FLO signal. The FLO roll off will help in reducing interference and it will lead to detection of much weaker tone power levels. FLO operation will also benefit from a tone located outside the band of operation compared to a tone in-band. The effect of an out of band tone on FLO receiver is as follows. The tone gets attenuated by the front end filters in the receiver (most of the attenuation comes from the digital filter in the Sigma-Delta A/D converter) and then gets aliased back in to the FLO FFT band. FLO signal is sampled at fₛ=5.55 MH so that a tone at location fₜₒₙₑ gets aliased in band at a frequency of fₜₒₙₑ-fₛ. fₜₒₙₑ can be chosen so that fₜₒₙₑ-fₛ is outside the active FLO band to minimize the impact on FLO performance. In addition, a benefit will obtained of the receive filter attenuation on the tone which reduces the interference from the tone.

In one aspect, the out of band CW tone location can occur within the guard band region of a spectrum.

It should be noted that the CW tone can be distinguished from a usual pilot signal in that pilot signals are not usually intended to be continuous nor are they intended to be transmitted within a guard band.

In addition to the tone location, another important aspect is the tone power that can be transmitted to provide a significant coverage region for the tone while not affecting the performance of the existing FLO network.

The following are of interest as related to the CW tone:

Tone Location: f_{Tone}

As noted above, it is advisable to place the tone within the guard band. At the receiver, assuming a signal centered at zero having, for instance, a 5.55 MHz spectrum (i.e., from −2.775 MHz to 2.775 MHz), the tone is placed within the guard band at for instance, fₜₒₙₑ=2.8 MHz or −2.8 MHz.

Tone Power: P_{Tone}

This is the signal power measured in the resolution bandwidth of the spectrum analyzer at the location of interest, in the absence of any interferers.

FLO Power: P_{FLO}

P_{FLO} corresponds to FLO signal power measured in the sub-carrier bandwidth, (e.g., 5.55 MHz) at the receiver.

FLO Bandwidth: W

W is 5.55 MHz for FLO deployment in US.

FLO Spectrum Roll Off at the Tone Location: α

α measures the spectrum roll off at the tone location with respect to the edge of the FLO band. For fₜₒₙₑ=2.8 MHz, α=40 dB

Receiver Filter (not Shown) Gain at the Tone Location: G_{Rx}

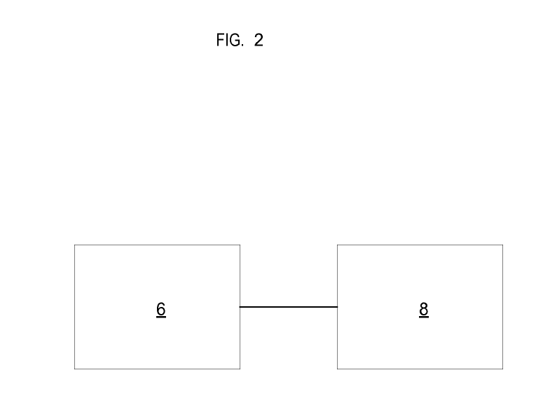

With reference to FIG. 2, a FLO receive filter 6 (a combination of SAW filter, analog baseband filter and the digital filter), connected to receiver 8 attenuates the tone which is out of band depending on the location of the tone. Most of the attenuation for tone locations close to the edge of the band comes from the digital filter.

Spectrum Analyzer Resolution Bandwidth: RBW

There is a trade off in the Doppler resilience and the signal level sensitivity that can be achieved in tone detection obtained via the spectrum analyzer bandwidth. In order to allow for tone detection at vehicular speeds of up to 120 km/hr (or 80 Hz at 700 MHz carrier frequency), the resolution bandwidth should be at least 80 Hz. Allowing for some extra room, we recommend RBW=300 Hz. Note that most of the spectrum analyzers allow resolution bandwidths that are of the form 10ⁿ Hz or 3×10ⁿ Hz where n is an integer.

Spectrum Analyzer Noise Figure: N_{f}

A typical number for N_{f} is about 20 dB.

Noise Spectral Density: N_{O}

Noise spectral density at 25 C given by −173.86 dBm/Hz

Displayed Average Noise Level: DANL

With a 20 dB noise figure, DANL turns out to be −153.86 dBm/Hz

Carrier to Interference (C/I) Required for Tone Detection:

$${( \frac{C}{I} )}_{tone , min}$$

In order to ensure that the tone detection as well as tone power measurement are accurate, we require that

$${( \frac{C}{I} )}_{tone , min}$$

be greater than or equal to 10 dB in the resolution bandwidth used for tone detection. The interference in this case comes from thermal noise as well as the leakage of FLO power into the band of tone.

C/I Required for FLO Detection:

$${( \frac{C}{I} )}_{FLO , min}$$

The continuous wave tone transmitted in the guard band at, for instance, transmitter Tx2 can be negatively affected by the normal operation of transmitter Tx1 transmitting, for instance a FLO signal. The presence of a tone affects FLO in two different ways. FLO acquisition based on TDM1 detection at a receiver is affected in the presence of a narrow band jammer such as a tone thus leading to false acquisitions at a receiver.

FLO demodulation at a receiver also gets affected due to the interference caused by the tone thus leading to erasures in data packets. Assuming FLO spectrum is relatively flat in the FLO active band, the spectral density at the band edge is given by

$$\frac{{P}_{FLO}}{W} dBm \text{/} Hz .$$

Given the roll off α dB at the tone location, FLO spectral density at the tone location is given by

$$( \frac{{P}_{FLO}}{W} - α ) dBm \text{/} Hz .$$

The total thermal noise and interference from FLO signal in the resolution bandwidth of the spectrum analyzer is then given by

$$( \frac{{P}_{FLO}}{W} - α ) \times RBW + {N}_{0} \times RBW + {N}_{f} .$$

$${( \frac{C}{I} )}_{tone}$$

is given by

$${( \frac{C}{I} )}_{tone} = \frac{{P}_{tone}}{( \frac{{P}_{FLO}}{W} - α ) ( RBW ) + {N}_{o} ( RBW ) + {N}_{f}}$$

With reference to FIG. 1, this ratio provides a measure of what transmitter Tx2, which is transmitting a CW tone, sees from transmitter Tx1 which is operating normally (e.g., transmitting a FLO signal).

In addition to the signal (e.g. FLO signal) from transmitter Tx1 affecting the reception of a CW tone from transmitter Tx2, the CW tone from Tx2 can adversely affect the signal (e.g., FLO signal) from transmitter Tx1. The carrier to interference ratio for a receiver interested in the FLO signal from TX1 based on the attenuation of CW tone due to the front end filters in the receiver is calculated as follows:

$${( \frac{C}{I} )}_{FLO} = \frac{{P}_{FLO}}{{P}_{tone} {G}_{Rx}}$$

The tone receiver (or the spectrum analyzer) has an advantage in terms of the receiver sensitivity or the minimum tone power that can be detected compared to the FLO receiver. The minimum tone power that can be detected by the tone receiver is given by the following:

$${P}_{tone , min} ( dBm ) = {( \frac{C}{I} )}_{tone , min} ( dB ) + ( ( \frac{{P}_{FLO}}{W} - α ) ( RBW ) + {N}_{o} ( RBW ) ) + {N}_{f} ) ( dBm )$$

where P_{FLO} is the FLO signal power from the neighboring site at the required edge of coverage for the tone.

The tone power that needs to be radiated to ensure equivalent coverage as a FLO signal at full power is given by

$${P}_{tone , rad} ( dBm ) = ( {P}_{FLO , rad} ) ( dBm ) - ( {P}_{FLO , min} ) ( dBm ) + {( \frac{C}{I} )}_{tone , min} ( dB ) + ( ( \frac{{P}_{FLO}}{W} - α ) ( RBW ) + {N}_{o} ( RBW ) ) + {N}_{f} ) ( dBm )$$

All the transmit tone power numbers indicated correspond to the radiated tone power from the antenna. The FLO transmit chain typically consists of the transmit waveform going through the transmit filter and then gets radiated through the antenna. The power at the output of the transmitter is referred to as TPO. The power at the output of the transmit filter is TPOF. In the case of the tone, there will be significant attenuation going through the transmit filter since the tone is place outside the FLO band of operation. Therefore TPOF for the tone will be significantly lower than the TPO. Finally, the cable loss from the filter to the antenna and the antenna gain should both be taken into account while comparing the radiated signal power to TPOF.

The tone location will also be governed by the attenuation of the transmit filter. The attenuation at 2.8 MHz due to the transmit filter may be too high, thus resulting in large TPO for the required TPOF. In such cases, the tone location will have to be moved closer to the band edge to lower the TPO required. The implication on such a shift towards the band edge would be only on the FLO performance and not on tone detection capability.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A method of identifying transmitter parameters of a transmitter comprising:
transmitting a continuous wave tone from the transmitter within the guard band of a spectrum.

2. A method of identifying the transmitter parameters of a transmitter as recited in claim 1 where the transmitter parameters comprise of the network coverage of the transmitter.

3. A method as recited in claim 1 where the transmitter transmitting the tone operates in the overlapping coverage region as one or more other transmitters transmitting an OFDM signal in a single frequency network

4. A method of identifying the transmitter parameters of a transmitter as recited in claim 1 where the spectrum has a bandwidth of 5.5 MHz.

5. A method as recited in claim 1 wherein the spectrum has a bandwidth of less than 8 MHz.

6. A method of identifying transmitter parameters comprising the steps of:
receiving a CW tone, corresponding to a transmission of the CW tone in guard band of the transmitter, from the transmitter;
measuring, at various geographic locations, the power of the tone received;
determining transmitter parameters for the transmitter based on measurements of the received CW tone.

7. A method as recited in claim 6 where the CW tone power is measured using a spectrum analyzer.

8. A method as recited in claim 6 where the measured CW tone power is used to tune network prediction tools to be used planning the network coverage of an OFDM broadcast network.

9. A method of identifying transmitter parameters of a transmitter comprising:
transmitting a continuous wave tone outside of an active band of the transmitter.

10. A method of identifying transmitter parameters comprising the steps of:
receiving a CW tone, corresponding to a transmission of the CW tone outside of an active band of the transmitter, from the transmitter;
measuring, at various geographic locations, the power of the tone received;
determining transmitter parameters for the transmitter based on measurements of the received CW tone.

11. A method of identifying a transmitter comprising:
transmitting a tone outside of an active band of the transmitter.

12. A method as recited in claim 11 wherein said tone is a continuous wave tone.
